(19) United States
(12) Patent Application Publication
(10) Pub. No.: US 2011/0068755 A1
(43) Pub. Date: Mar. 24, 2011

(54) METHOD FOR OPTIMIZING THE EFFICIENCY OF AN ENERGY SYSTEM

(76) Inventors: Arthur SCHAEFERT, Buehlertal (DE); Boris Blaumeiser, Zuerich (CH); Thomas Schneider, Bad Koenigshofen (DE)

(21) Appl. No.: 12/888,966

(22) Filed: Sep. 23, 2010

(30) Foreign Application Priority Data
Sep. 23, 2009 (DE) 10 2009 029 689.1

(51) Int. Cl. G05F 1/46

(52) U.S. Cl. 323/234

(57) ABSTRACT

The invention relates to a method for optimizing the efficiency of an energy system, which system has at least one energy unit that is coupled to a control unit and a DC/DC converter for regulating the power output of the energy unit, and the control unit regulates the power output to an electrical component via the DC/DC converter as a function of an operating state of the energy system. According to the invention, it is provided that the energy unit communicates with an observer via a first information channel, and information from the energy unit is transmitted during the operation of the energy system via the first information channel to the observer, which from the transmitted information ascertains the efficiency performance of the energy unit and transmits the efficiency performance to the control unit via a second information channel, as a result of which the overall efficiency of the energy system is improved.

### CROSS-REFERENCE TO RELATED APPLICATION

This application is based on German Patent Application 10 2009 029 689.1 filed on Sep. 23, 2009.

### BACKGROUND OF THE INVENTION

1. Field of the Invention

The invention relates to a method for optimizing the efficiency of an energy system, which system has at least one energy unit that is coupled to a control unit and a DC/DC converter for regulating the power output of the energy unit, and the control unit regulates the power output to an electrical component via the DC/DC converter as a function of an operating state of the energy system.

2. Description of the Prior Art

From German Patent Disclosure DE 102 23 117 A1, it is known that energy systems are constructed of a plurality of partial components. The performance and in particular the efficiency performance of the components and partial systems has an influence on the mode of operation of the entire energy supply system. To optimize the efficiency of an energy system, load point shifts are performed and in the process energy is loaded into a store or drawn from it. To be able to make appropriate use of these load point shifts for optimizing the efficiency, it is necessary to know the efficiency performance of the partial systems and components. In a fuel cell energy supply system, for instance, this is the efficiency performance of a fuel cell unit, an energy store, and an energy conversion system (DC/DC converter). This efficiency performance of the partial components is ascertained in the development process, and these values or characteristic curves or families of characteristic curves are implemented in the energy management of the energy system.

### OBJECT AND SUMMARY OF THE INVENTION

It is the object of the present invention to create both an improved method for operating an energy system and an associated apparatus for optimizing the efficiency of an energy system.

According to the invention, it is provided that the energy unit communicates with an observer via a first information channel, and information from the energy unit is transmitted during the operation of the energy system via the first information channel to the observer, which from the transmitted information ascertains the efficiency performance of the energy unit and transmits the efficiency performance to the control unit via a second information channel, as a result of which the overall efficiency of the energy system is improved.

It is especially advantageous that the observer acquires the information from the energy unit for ascertaining the efficiency performance via the first information channel during operation. Continuous acquisition of data about the efficiency performance of the energy unit is thus possible. The information channels can be switched on or off in order effectively and in a targeted way to transmit information between the observer and the energy unit. Moreover, it can thereby be ensured that replacement of the energy unit or of the observer can be done during operation, without suffering a loss of information. Accordingly, the observer is capable at any time during operation of the energy system of ascertaining the efficiency performance of the energy unit. The efficiency performance is stored in memory by means of a characteristic efficiency curve in a coordinate system, in which the power is plotted on the x axis and the efficiency is plotted on the y axis.

It is furthermore advantageous that an electrical component is set by the DC/DC converter via defined intermediary steps until reaching a defined operating state and in the process, information about the individual operating states of the DC/DC converter and/or the energy unit, which are partial components of the energy system, are transmitted to the observer in data packets. Plotting information about individual operating states serves the purpose of ascertaining an accurate efficiency performance of the energy unit and/or the DC/DC converter. By means of a targeted approach to operating states of the individual energy stores and/or DC/DC converter, accurate plotting of the characteristic efficiency curve of these components over a wide power range is made possible. Moreover, logging of the efficiency performance of the components is possible outside regular operation of the energy system as well. To that end, the efficiency performance and plotting of the characteristic efficiency curve of the components can be done in a measurement and calibration phase, as is possible for instance in the context of a service interval that must necessarily be adhered to. Ascertaining characteristic efficiency curves can also be done for other partial components used in the energy system. These partial components may for instance be a fuel cell unit, a traction reservoir, an internal combustion engine, a transmission, an on-board traction network, or a drive machine. These partial components can then be coupled to the observer so that the efficiency performance of these partial components can also be ascertained. Because the observer evaluates the information, it is possible for mechanical systems as well to ascertain an evaluation of the efficiency from transmitted rpm and torque information. For ascertaining efficiency of a fuel cell unit as well, the information can be set in relation to the electrical net output power by way of the water consumption. To that end, the current and voltage of the fuel cell unit are measured, as is the electrical consumption of the secondary units, and the net output power is ascertained. The water consumption can be found via an H₂ flow rate sensor or via an estimated model on the basis of triggering an H₂ metering valve. Transmitting the efficiency to the control unit on the one hand enables redundant data retention, and on the other makes it possible for the efficiency to have to be calculated only by a partial component of the entire system. The data packets are closed data units, which have a well-defined length and form. The data packets furthermore include important addressing and administrative information for sending the packet to the correct addressees. Primarily, an IP-based network can be used to exchange information by means of data packets. However, the use of other protocols is also possible, such as UDP, TCP, DHCP, HTTP, FDP, Telnet, SSH, POP3, SMTP, IMAP, or NNTP.

It has also proved advantageous that after a power failure, the observer ascertains the characteristic efficiency curves from the persistently stored data. As a result, the efficiency performance need not necessarily be found to determine the characteristic efficiency curves after the energy system has been put into operation. It is also possible for a plurality of characteristic curves per partial component to be stored in memory, which makes analysis and evaluation of the efficiency performance possible over the service life of the partial component. It is furthermore possible for previous characteristic efficiency curves, plotted from structurally identical partial components, to be stored in the memory of the observer.

It is especially advantageous that the observer, the data packets are stored in persistent and/or transient form in a memory. Since the data packets can contain not only the information but also addressing and administrative information and/or time information, the efficiency performance of the partial component can be ascertained at any time. In the event of a failure of the data stream between the partial component and the observer, it is thus possible to ascertain the efficiency exactly up to the time of rupture in the data stream. It is also conceivable that on resumption of data acquisition, the missing information is ascertained by interpolation in the observer.

It is also advantageous that the control unit performs an optimization of the energy store as a function of the ascertained efficiency performance via load point shifts. As a result, a optimizing the efficiency of the entire system is also purposefully done if the component performance changes. Thus the energy management intervenes in a controlled fashion in the mode of operation of the energy system so as to optimize the overall efficiency of the entire system.

The object of the invention is also attained by an apparatus for optimizing the efficiency of an energy system, which system has at least one energy unit that is coupled to a control unit and a DC/DC converter for regulating the power output of the energy unit, and the control unit regulates the power output to an electrical component via the DC/DC converter as a function of an operating state of the energy system. To that end, it is provided according to the invention that the energy unit communicates with an observer via a first information channel, and information from the energy unit is transmitted during the operation of the energy system via the first information channel to the observer, as a result of which, from the transmitted information, the efficiency performance of the energy unit can be ascertained by the observer, and the efficiency performance can be transmitted to the control unit via a second information channel.

It is especially advantageous that the energy unit is an energy store, in particular a capacitor, an ELDC (electrochemical double layer capacitor) or a rechargeable battery. Because of the high energy density of these energy stores, it is possible even to operate electrical components that have high power demands. Moreover, peak power levels of the electrical component that are briefly required can be covered. Since the electrical component can be an electric motor and/or a generator or a combined generator/motor unit, the energy generated by the generator can be returned to the energy stores again. Thus the use of the energy system in a motor vehicle can be made possible.

It is furthermore advantageous that a fuel cell unit and an energy store are coupled to the DC/DC converter, and the DC/DC converter controls the first energy stream and the second stream flow in such a way that the electrical component is supplied with energy, or the energy generated by the electrical component is returned to the energy store. Thus again, the use of the energy system in a motor vehicle is conceivable. An electric motor, which as a drive mechanism is coupled to a first axle of the motor vehicle can thus drive a motor vehicle. Moreover, it can be provided that a generator is mounted on the second axle of the motor vehicle and returns excess consumed energy to the energy store via the DC/DC converter. It is conceivable for fuel cell unit and the drive to be directly connected and for the energy store to be coupled to the drive via the DC/DC converter.

It is advantageous that the energy unit and/or the DC/DC converter has sensors for ascertaining characteristic efficiency curves. The sensors may be sensors that measure the voltage and the current of the partial component in order to determine the power consumption of the partial component. In mechanical systems, the power can be ascertained via rpm and torque sensors. The sensors may have an independent central processing unit, for transmitting the picked-up information to the observer. Moreover, the observer can also have a central processing unit, which processes the transmitted data from the sensors independently of a central processing unit. Thus for the entire system, the computation load is distributed over a plurality of partial components, such as the observer, the control unit, and/or the sensors. It is also conceivable for the individual sensors not to send the ascertained information to the observer constantly, but instead to store it in transient and/or persistent form in order to transmit it to the observer in accordance with a defined rule. Furthermore, the observer can independently transmit inquiries about updated information to the sensors in order to initiate a data exchange.

It is also advantageous that the observer has at least one interface which can be connected to a sensor. By means of this interface, it is possible to exchange information between the interface and the sensor. Moreover, the interface can supply the sensor with energy. This makes the use of active sensors possible for acquiring power data that are required for calculating the efficiency. Furthermore, it is conceivable for the interface to exchange information with the sensor in wireless fashion.

It is especially advantageous that the interface of the observer employs at least one of the following technologies: cables, twisted-pair cables, UTP cables, FTP cables, ITP cables, cables with WARP technology, in particular cables in one of the categories 1, 2, 3, 4, 5, 6, 7 or 7a, Bluetooth, Infrared Data Association (IrDA), ZigBee, Near Field Communication (NFC), Wireless Local Area Network (WLAN), WiMAX, in particular in accordance with a standard of IEEE 802, Wibree, FireWire, USB, Wireless USB, inductive data transmission, capacitive data transmission, GSM, GPRS, UMTS, HSCSD, or HSDPA. Thus wireless and/or wire-bound versions can be created. In the wire-bound versions, a data cable with a shield can be employed, so that electromagnetic interference from outside can be maximally shielded against. Moreover, the cable-bound version has the advantage that by way of it, the connected components can also be supplied with energy. A central energy supply can thus be ensured. In the wireless technologies, it is especially advantageous that the effort and expense otherwise required for wiring, as in the wire-bound systems, is eliminated. Moreover, technologies can be utilized that have a wide transmission and reception radius. As an example, the GSM standard can be used, which can make it possible to exchange data between a transmitter and a receiver at a distance of 35 km. Evaluation of the wirelessly transmitted data can thus be done regardless of location.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 is a schematic view of an energy system having an electrical component;

FIG. 2 is a schematic view of an energy system having a fuel cell unit and an energy unit, which are coupled to a DC/DC converter; and

FIG. 3 is a flow chart for illustrating the method of the invention.

### DESCRIPTION OF THE PREFERRED EMBODIMENTS

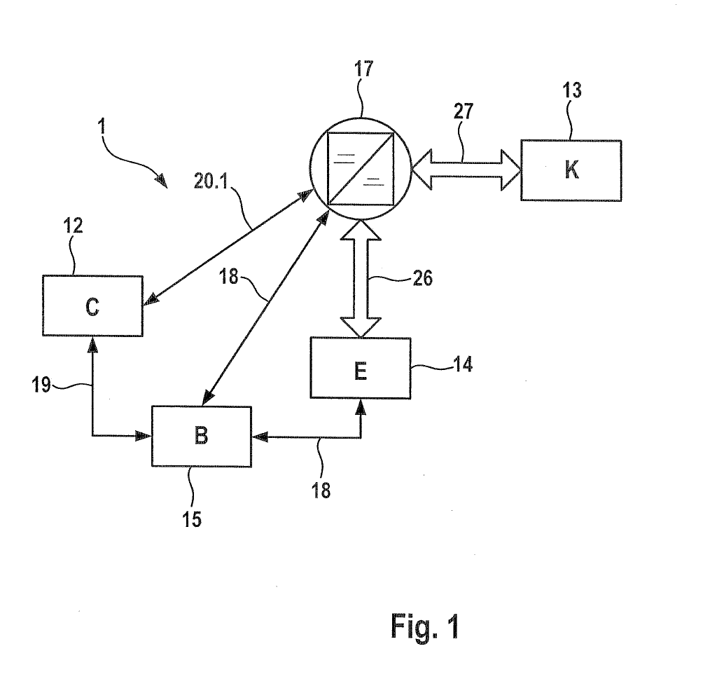

In FIG. 1, an energy system 1 is schematically shown, in which an energy unit 14 is coupled to an observer 15 via a first information channel 18. Thus information, particular about the efficiency performance of the energy unit 14, can be exchanged between the observer 15 and the energy unit 14. Moreover, the observer 15 is coupled to a control unit 12 via a second information channel 19. Here as well, information that is used for the energy management of the energy unit connected to the control unit 12 can be exchanged via the second information channel 19. A control line 20.1 between the control unit 12 and a DC/DC converter 17 makes the energy management possible, particularly in that the DC/DC converter shifts the load point. This is done by controlling the power consumption for an electrical component 13 connected to the DC/DC converter. As a result, a first energy flow 26, which can be made possible between the energy unit 14 and the DC/DC converter 17, is controlled. The electrical component is then supplied with energy by a second energy flow 27, which can be made possible between the DC/DC converter and the electrical components 13.

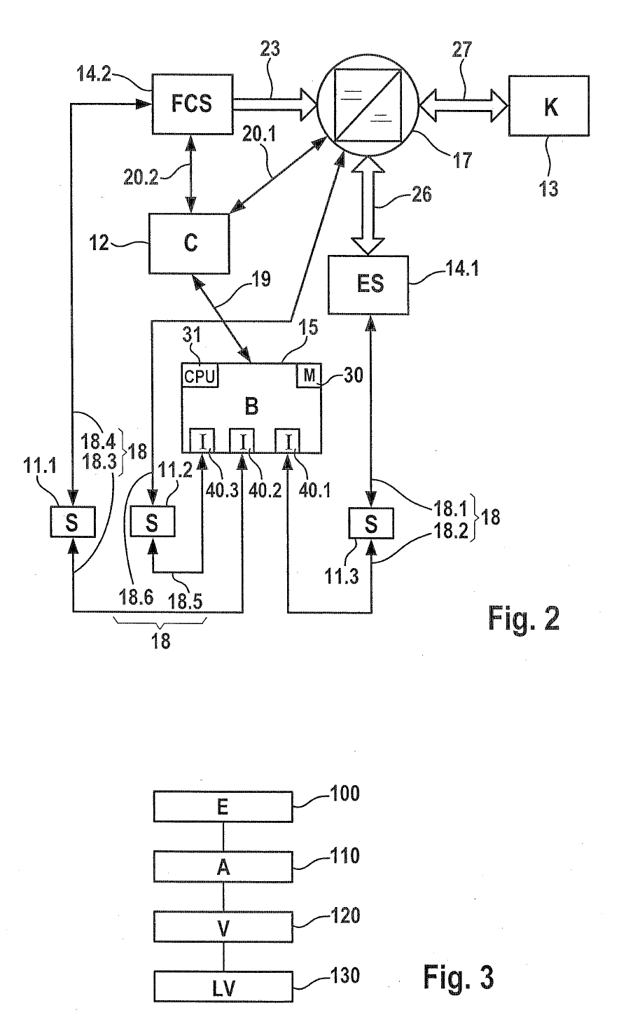

In FIG. 2, an energy system with a fuel cell unit 14.2 and an energy store 14.1, which are each coupled to a DC/DC converter 17, is shown schematically. The fuel cell unit 14.2 is connected to a sensor 11.1 via a first information channel 18.4, and the sensor 11.1 is likewise coupled to the observer 15 via a first information channel 18.3. Data that the sensor 11.1 records about the efficiency performance of the fuel cell unit 14.2 are transmitted to the observer 15. The energy store 14.1 is connected to a sensor 11.3 via a first information channel 18.1, and the sensor 11.3 is likewise coupled to the observer 15 via a first information channel 18.2. Data that the sensor 11.3 records about the efficiency performance of the energy store 14.1 are transmitted to the observer 15. The DC/DC converter 17 is also connected via a first information channel 18.6 to a sensor 11.2, and the sensor 11.2 is likewise coupled via a first information channel 18.5 to the observer 15. Data that the sensor 11.2 records about the efficiency performance of the DC/DC converter 17 are likewise transmitted to the observer 15. The observer 15 has a central processing unit 31, in which the data are processed, and a memory 30, in which the data are stored. Thus the observer 15 is capable of ascertaining the characteristic efficiency curve of the fuel cell unit 14.2, of the energy store 14.1, and of the DC/DC converter 17. The individual sensors are connected to the observer 15 via interfaces 40.1, 40.2, 40.3. The interfaces 40.1, 40.2, 40.3 can supply the sensors with energy. However, the energy supply to the sensors 11.1, 11.2, 11.3 via the individual partial components is also conceivable, in particular the fuel cell unit 14.2 and/or the energy store 14.1. The fuel cell unit 14.2 is connected to the control unit 12 via a control channel 20.2. Via this channel, from the characteristic curves ascertained, the necessary efficiency required for optimizing the overall efficiency can be established. The DC/DC converter 17 is likewise connected to the control unit 12 via a control channel 20.1, by way of which a signal exchange can take place, particularly for optimizing the efficiency performance of the entire system. The control channel 20.2 can be used for degradation, in particular for targeted degradation of the fuel cell unit 14.2. The targeted approach of operating states of the partial components of the system is also possible via the control channel 20.1, 20.2. The energy flow between the fuel cell unit 14.2 and the DC/DC converter 17 takes place via a third energy flow 23, which in particular is oriented unidirectionally. The energy flow between the energy store 14.1 and the DC/DC converter 17 takes place via a first energy flow 26, which in particular is oriented bidirectionally. Between the electrical component 13 and the DC/DC converter 17, there is also a second energy flow 27, which is in particular oriented bidirectionally. Energy that is generated by the electrical component 13 can thus be stored in the energy store 14.1, the energy being returned via the second energy flow 27, the DC/DC converter 17, and the first energy flow 26. The observer 15 and the control unit 12 can be integrated in a single component.

In FIG. 3, further explanation is to be provided in terms of the flow chart. First, in the context of data acquisition 100 by the sensors 11.1, 11.2, 11.3 in FIG. 2, an analysis and evaluation 110 takes place. The evaluation of the data serves to determine the updated efficiency performance and to ascertain the characteristic efficiency curve of a partial component. From the efficiency performance ascertained and from the characteristic efficiency curve determined, the individual partial components can be controlled in such a way that the efficiency of the entire system 1 is optimized. To ensure continuous optimization, in particular during operation, load point shifts based on the calculated characteristic efficiency curves are performed, to ensure the efficiency in an energy supply system, in particular a hybrid energy supply system. A comparison 120 of the updated efficiency performance with the ascertained characteristic efficiency curves makes it possible to take the necessary steps for a load point shift 130 in a targeted way. Constant data plotting for detecting efficiency and comparison with the calculated characteristic efficiency curves make it possible to optimize the efficiency performance, and in particular to optimize the efficiency performance of the entire system constantly.

The foregoing relates to preferred exemplary embodiments of the invention, it being understood that other variants and embodiments thereof are possible within the spirit and scope of the invention, the latter being defined by the appended claims.

1. A method for optimizing the efficiency of an energy system, which system has at least one energy unit that is coupled to a control unit and to a DC/DC converter for regulating power output of the energy unit, and the control unit regulates the power output to an electrical component via the DC/DC converter as a function of an operating state of the energy system, comprising the steps of:
having the energy unit communicate with an observer via a first information channel;
transmitting information from the energy unit during operation of the energy system via the first information channel to the observer,
ascertaining from the transmitted information an efficiency performance of the energy unit and
transmitting the efficiency performance to the control unit via a second information channel, as a result of which overall efficiency of the energy system is improved.

2. The method as defined by claim 1, wherein the observer acquires the information from the energy unit for ascertaining the efficiency performance via the first information channel during operation.

3. The method as defined by claim 1, wherein an electrical component is set by the DC/DC converter via defined intermediary steps until reaching a defined operating state and during which, information about individual operating states of the DC/DC converter and/or the energy unit are transmitted to the observer in data packets.

4. The method as defined by claim 2, wherein an electrical component is set by the DC/DC converter via defined intermediary steps until reaching a defined operating state and during which, information about individual operating states of the DC/DC converter and/or the energy unit are transmitted to the observer in data packets.

5. The method as defined by claim 3, wherein in the observer, the data packets are stored in persistent and/or transient form in a memory.

6. The method as defined by claim 4, wherein in the observer, the data packets are stored in persistent and/or transient form in a memory.

7. The method as defined by claim 1, wherein after a power failure, the observer ascertains characteristic efficiency curves from persistently stored data.

8. The method as defined by claim 1, wherein the control unit performs an optimization of an energy store as a function of the ascertained efficiency performance via load point shifts.

9. An apparatus for optimizing the efficiency of an energy system having at least one energy unit that is coupled to a control unit and a DC/DC converter for regulating power output of the energy unit, and the control unit regulates the power output to an electrical component via the DC/DC converter as a function of an operating state of the energy system, wherein the energy unit communicates with an observer via a first information channel, and information from the energy unit is transmitted during the operation of the energy system via the first information channel to the observer, as a result of which, from the transmitted information, an efficiency performance of the energy unit can be ascertained by the observer, and the efficiency performance can be transmitted to the control unit via a second information channel.

10. The apparatus for optimizing the efficiency of an energy system as defined by claim 9, wherein the electrical component is an electric motor and/or a generator.

11. The apparatus for optimizing the efficiency of an energy system as defined by claim 9, wherein the energy unit is an energy store, in particular a capacitor, an ELDC (electrochemical double layer capacitor) or a rechargeable battery.

12. The apparatus for optimizing the efficiency of an energy system as defined by claim 10, wherein the energy unit is an energy store, in particular a capacitor, an ELDC (electrochemical double layer capacitor) or a rechargeable battery.

13. The apparatus for optimizing the efficiency of an energy system as defined by claim 9, wherein a fuel cell unit and an energy store are coupled to the DC/DC converter, and the DC/DC converter controls a first energy flow and a third energy flow in such a way that the electrical component is supplied with energy, or the energy generated by the electrical component is returned to the energy store.

14. The apparatus for optimizing the efficiency of an energy system as defined by claim 10, wherein a fuel cell unit and an energy store are coupled to the DC/DC converter, and the DC/DC converter controls a first energy flow and a third energy flow in such a way that the electrical component is supplied with energy, or the energy generated by the electrical component is returned to the energy store.

15. The apparatus for optimizing the efficiency of an energy system as defined by claim 11, wherein a fuel cell unit and an energy store are coupled to the DC/DC converter, and the DC/DC converter controls a first energy flow and a third energy flow in such a way that the electrical component is supplied with energy, or the energy generated by the electrical component is returned to the energy store.

16. The apparatus for optimizing the efficiency of an energy system as defined by claim 12, wherein a fuel cell unit and an energy store are coupled to the DC/DC converter, and the DC/DC converter controls a first energy flow and a third energy flow in such a way that the electrical component is supplied with energy, or the energy generated by the electrical component is returned to the energy store.

17. The apparatus for optimizing the efficiency of an energy system as defined by claim 9, wherein the energy unit and/or the DC/DC converter has sensors for ascertaining characteristic efficiency curves.

18. The apparatus for optimizing the efficiency of an energy system as defined by claim 9, wherein the observer has at least one interface which is connectable to a sensor.

19. The apparatus for optimizing the efficiency of an energy system as defined by claim 18, wherein the interface of the observer employs at least one of the following technologies: cables, twisted-pair cables, UTP cables, FTP cables, ITP cables, cables with WARP technology, in particular cables in one of the categories 1, 2, 3, 4, 5, 6, 7 or 7a, Bluetooth, Infrared Data Association (IrDA), ZigBee, Near Field Communication (NFC), Wireless Local Area Network (WLAN), WiMAX, in particular in accordance with a standard of IEEE 802, Wibree, FireWire, USB, Wireless USB, inductive data transmission, capacitive data transmission, GSM, GPRS, UMTS, HSCSD, or HSDPA.

20. The apparatus for optimizing the efficiency of an energy system as defined by claim 9, which can be operated by a method comprising the steps of:
having the energy unit communicate with an observer via the first information channel;
transmitting information from the energy unit during operation of the energy system via the first information channel to the observer,
ascertaining from the transmitted information the efficiency performance of the energy unit and
transmitting the efficiency performance to the control unit via the second information channel, as a result of which overall efficiency of the energy system is improved.
